(19) United States
(12) Patent Application Publication
(10) Pub. No.: US 2015/0120861 A1
(43) Pub. Date: Apr. 30, 2015

(54) METHOD AND DEVICE FOR OBTAINING CONTENTS OF PAGE, APPLICATION APPARATUS AND MOBILE TERMINAL

(71) Applicant: Tencent Technology (Shenzhen) Company Limited, Shenzhen (CN)

(72) Inventors: Jiangquan Huang, Shenzhen (CN); Lier Feng, Shenzhen (CN)

(73) Assignee: Tencent Technology (Shenzhen) Company Limited

(21) Appl. No.: 14/592,670

(22) Filed: Jan. 8, 2015

Related U.S. Application Data
(63) Continuation of application No. PCT/CN2014/076381, filed on Apr. 28, 2014.

(30) Foreign Application Priority Data
Jun. 7, 2013 (CN) 201310226017.4

(51) Int. Cl. H04L 29/08

(52) U.S. Cl. CPC H04L 67/2842
USPC 709/213

(57) ABSTRACT

A method and a device for obtaining contents of a page, an application apparatus and a mobile terminal are disclosed. The method includes: sending a request for obtaining the page to a page server by a first website loading module; intercepting the request for obtaining the page by an intercepting module; sending the request for obtaining the page to a proxy module by a second website loading module; obtaining the contents of the page by the proxy module based on the request for obtaining the page; returning the contents of the page to the second website loading module by the proxy module; and returning the contents of the page by the second website loading module. With the technical solution, the loading speed may be increased, the loading time may be reduced and the loading efficiency may be improved.

### CROSS-REFERENCE TO RELATED APPLICATIONS

The present application is a continuation of PCT/CN2014/076381, filed on Apr. 28, 2014 and entitled “METHOD AND DEVICE FOR OBTAINING CONTENTS OF PAGE, APPLICATION APPARATUS AND MOBILE TERMINAL”, which claims the priority to Chinese Patent Application No. 201310226017.4, entitled “METHOD AND DEVICE FOR OBTAINING CONTENTS OF PAGE, APPLICATION APPARATUS AND MOBILE TERMINAL”, filed on Jun. 7, 2013 with State Intellectual Property Office of People's Republic of China, both of which are incorporated herein by reference in their entirety.

### TECHNICAL FIELD

The present disclosure relates to Internet technologies, and in particular, to a method and a device for obtaining contents of a page, an application apparatus and a mobile terminal

### BACKGROUND

With rapid development of smart terminals, more and more people may surf the Internet, for example, browse web pages, etc., with mobile terminals. For instance, a user may load and view contents of the webpage through a system interface in an operating system of the mobile terminal, where the system interface may be called a built-in browser control. As an example, in the iPhone Operating System (iOS), developed for iPhone by the Apple Inc., the contents of the webpage are loaded and presented by a system interface UIWebView, and the contents of the webpage, loaded and presented by the UIWebView, are displayed to the user through a display device of the mobile terminal

Nowadays, the UIWebView is applied in many applications in the iOS. The UIWebView is applied not only in dedicated browser applications, but also in other applications required to display the contents of webpages. FIG. 1 is a signaling diagram of loading a page with the system interface UIWebView. As shown in FIG. 1, the signaling includes steps 1-4. In step 1, when opening the page by using the system interface UIWebView, i.e., when the system interface UIWebView loads the page, the system interface UIWebView loads the address (for example, a Uniform Resource Locator (URL)) of the page through a website loading module NSURLConnection. In step 2, the system interface UIWebView initiates a Hypertext transfer protocol (Http) Request, requesting for obtaining the contents of the page, to a page server through the website loading module NSURLConnection of the iOS. In step 3, the page server returns an Http Response, including page data requested by the Http Request, to the website loading module NSURLConnection. In step 4, the website loading module NSURLConnection returns the page data to the system interface UIWebView, so that the system interface UIWebView may load and present the page data.

In implementing the disclosure, inventors find that when loading the page by using the system interface UIWebView, loading speed, loading time and loading efficiency may be adversely affected when the page server is under heavy load.

### SUMMARY

A method and a device for obtaining contents of a page, an application apparatus and a mobile terminal are provided according to embodiments of the disclosure.

In one aspect, a method for obtaining contents of a page is provided. The method includes:
intercepting a request for obtaining the page by an intercepting module, where the request for obtaining the page is sent from a first website loading module to a page server;
sending the request for obtaining the page to a proxy module by a second website loading module;
obtaining the contents of the page by the proxy module based on the request for obtaining the page;
returning the contents of the page to the second website loading module by the proxy module; and
returning the contents of the page by the second website loading module.

In another aspect, a device for obtaining contents of a page is provided. The device includes:
an intercepting module, configured to intercept a request for obtaining the page, where the request for obtaining the page is sent from a first website loading module to a page server;
a second website loading module, configured to send the request for obtaining the page to a proxy module and to return the contents of the page received from the proxy module; and
the proxy module, configured to obtain the contents of the page based on the request for obtaining the page and to return the contents of the page to the second website loading module.

In still another aspect, an application apparatus is provided. The application apparatus includes the foregoing device for obtaining the contents of the page.

In further another aspect, a mobile terminal is provided. The mobile terminal includes the foregoing application apparatus.

Advantages of the technical solution according to the embodiments of the disclosure are described as follows.

In the technical solution according to the embodiments of the disclosure, the proxy module may obtain the contents of the page based on the request for obtaining the page and the proxy module may be arranged locally. Hence, the problem of slow loading speed, long loading time and low loading efficiency caused by the website loading module requesting the contents of the page from the page server during a heavy load of the page server is avoided. In the technical solution according to the embodiments of the disclosure, since the contents of the page may be obtained from the proxy module, the loading speed may be increased, the loading time may be reduced and the loading efficiency may be improved. In addition, with the technical solution according to the embodiments of the disclosure, the problem that the powerful proxy module in background is not fully used by the system interface is solved. By fully using the proxy module in loading the page, the efficiency of loading the page is improved and the user experience in loading the page is enhanced.

### BRIEF DESCRIPTION OF DRAWINGS

For explaining technical solutions according to embodiments of the disclosure more clearly, drawings used in the illustration of the embodiments of the disclosure are described briefly. Apparently, the drawings in the following description are merely some of the embodiments of the disclosure, and other drawings may be obtained based on the drawings by those skilled in the art without inventive efforts.

FIG. 1 is a signaling diagram of loading a page with a system interface UIWebView;

FIG. 2 is a schematic structure diagram of a device for obtaining contents of a page according to an embodiment of the disclosure;

FIG. 3 is a flow chart of a method for obtaining contents of a page according to an embodiment of the disclosure; and

FIG. 4 is a signaling diagram of a method for obtaining contents of a page according to an embodiment of the disclosure.

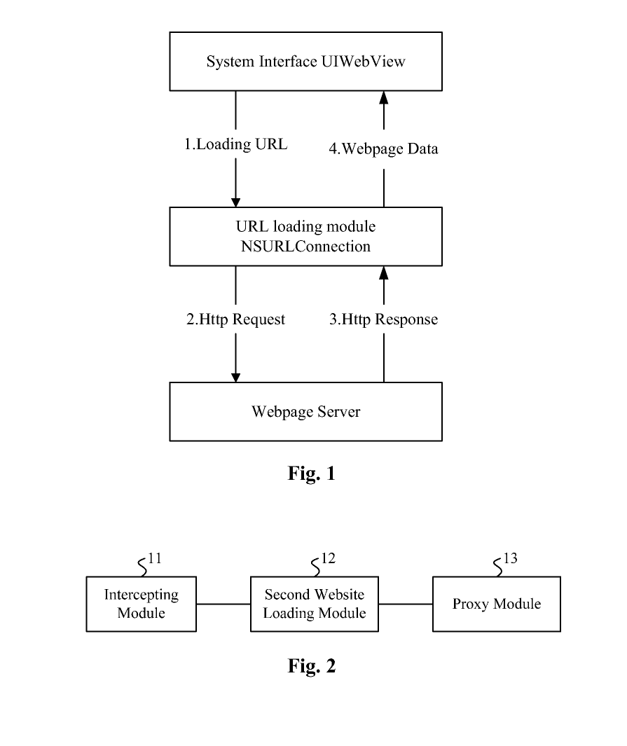

### DETAILED DESCRIPTION OF EMBODIMENTS

For illustrating a technical solution and advantages of the disclosure more clearly, embodiments of the disclosure are further described hereinafter in conjunction with drawings.

FIG. 2 is a schematic structure diagram of a device for obtaining contents of a page according to an embodiment of the disclosure. As shown in FIG. 2, the device for obtaining the contents of the page according to the embodiment may include an intercepting unit 11, a second website loading module 12 and a proxy module 13.

A first website loading module sends a request for obtaining the page to a page server. The process of requesting is taken place when a system interface intends to load and present the contents of the page. That is to say, when the system interface intends to load and present the contents of the page, the first website loading unit is correspondingly triggered to send the request for obtaining the page to the page server. The intercepting module 11, connecting with the first website loading module, is configured to intercept the request for obtaining the page sent to the page server by the first website loading module. The second website loading module 12 is configured to send the request for obtaining the page to the proxy module. The intercepting module 11, connecting with the second website loading module 12, is further configured to trigger the second website loading module 12 to send the request for obtaining the page to the proxy module 13 after the request for obtaining the page is intercepted by the intercepting module 11. The proxy module 13, connecting with the second website loading module 12, is configured to receive the request for obtaining the page sent by the second website loading module 12 and obtain the contents of the page based on the request for obtaining the page. For example, the proxy module may obtain corresponding contents of the page based on an URL included in the request for obtaining the page. The proxy module 13 is further configured to return the contents of the page to the second website loading module 12. The second website loading module 12 is further configured to return the contents of the page to the system interface, for loading and presenting the contents by the system interface.

The first website loading module according to the embodiment may be a website loading module NSURLConnection in the existing iOS platform. The request for obtaining the page may include the URL of the requested page. The proxy module 13 according to the embodiment may be a proxy server in background, where the proxy server in background may be arranged locally.

In the device for obtaining the contents of the page according to the embodiment, the contents of the page are obtained by using the modules with the following mechanism. When the system interface intends to load and present the contents of the page, the first website loading module sends the request for obtaining the page to the page server. When the intercepting module 11 detects the request for obtaining the page, the intercepting module 11 intercepts the request for obtaining the page and triggers the second website loading module 12 to transfer the request for obtaining the page to the proxy module 13. The proxy module 13 obtains the corresponding contents of the page based on the URL in the request for obtaining the page and returns the contents of the page to the second website loading module 12. In the end, the second website loading module 12 returns the contents of the page to the system interface. With this mechanism, the system interface may load and present the contents of the page.

With the modules in the device for obtaining the contents of the page according to the embodiment, the first website loading module sends the request for obtaining the page to the page server when the system interface intends to load and present the contents of the page; the intercepting module intercepts the request for obtaining the page; the second website loading module sends the request for obtaining the page to the proxy module; the proxy module obtains the contents of the page based on the request for obtaining the page; the proxy module returns the contents of the page to the second website loading module; and the second website loading module returns the contents of the page to the system interface, for loading and presenting the contents by the system interface. In the technical solution according to the embodiments of the disclosure, the proxy module may obtain the contents of the page based on the request for obtaining the page and the proxy module may be arranged locally. Hence, the problem of slow loading speed, long loading time and low loading efficiency caused by the website loading module requesting the contents of the page from the page server during a heavy load of the page server is avoided. In the technical solution according to the embodiment, since the contents of the page may be obtained from the proxy module, the loading speed may be increased, the loading time may be reduced, the loading efficiency may be improved, and the user experience of a mobile terminal may further be enhanced. In addition, with the technical solution according to the embodiment, the problem that the proxy module in background is not fully used by the system interface is solved. By fully using the proxy module in loading the page, the efficiency of loading the page is improved and the user experience in loading the page is enhanced.

According to another embodiment, the proxy module is configured to obtain the contents of the page from a local cache based on the request for obtaining the page. That is to say, the contents of the page are already accessed and are stored in the proxy module 13. The proxy module 13 may locally obtain the contents of the page based on the request for obtaining the page after the second website loading module 12 sends the request for obtaining the page to the proxy module 13. Accordingly, the contents of the page may be obtained locally, the efficiency of loading the page is improved and the user experience in loading the page is enhanced.

Alternatively, in the case the contents of the page corresponding to the request for obtaining the page are not locally stored in the proxy module 13, the proxy module 13 may send the request for obtaining the page to the page server and receive the corresponding contents of the page from the page server, where the corresponding contents of the page are sent by the page server based on the request for obtaining the page. Hence, it is ensured that the contents of the page, requested by the request for obtaining the page, may be correctly obtained.

According to yet another embodiment, a data transmission protocol between the second website loading module 12 and the proxy module 13 is different from a data transmission protocol between the proxy module 13 and the page server;

and/or the data transmission protocol between the second website loading module 12 and the proxy module 13 supports a higher data transmission rate than the data transmission protocol between the proxy module 13 and the page server.

For example, in the existing iOS platform, a Hypertext transfer protocol (Http) is applied between the website loading module NSURLConnection (an example of the first website loading module) and the page server. In addition to the existing iOS platform, a second website loading module may be added, for example, the second website loading module may be a website loading module Chromium net. For ensuring the loading efficiency, an SPDY data transmission protocol supporting a higher data transmission rate may be applied between the second website loading module and the proxy module, while the Http protocol is still applied between the proxy module and the page server. The SPDY data transmission protocol is an enhancement of the Http protocol and the data transmission rate may be significantly improved.

According to still another embodiment, the proxy module 13 is further configured to, after obtaining the contents of the page based on the request for obtaining the page and before returning the contents of the page to the second website loading module 12, process the contents of the page based on a page processing parameter in the request for obtaining the page.

The page processing parameter includes at least one of resource compression ratio, page size and a value reflecting whether to perform advertisement filtering.

In the technical solution according to the embodiments of the disclosure, the proxy module may obtain the contents of the page based on the request for obtaining the page and the proxy module may be arranged locally. Hence, the problem of slow loading speed, long loading time and low loading efficiency caused by the website loading module requesting the contents of the page from the page server during a heavy load of the page server is avoided. Hence, the loading speed may be increased, the loading time may be reduced, the loading efficiency may be improved, and the user experience of a mobile terminal may further be enhanced. In addition, with the technical solution according to the embodiment, the problem that the proxy module in background is not fully used by the system interface is solved. By fully using the proxy module in loading the page, the efficiency of loading the page is improved and the user experience in loading the page is enhanced.

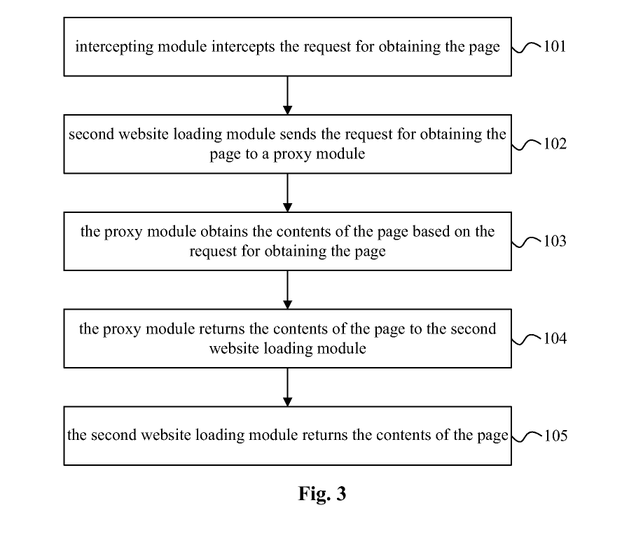

FIG. 3 is a flow chart of a method for obtaining contents of a page according to an embodiment of the disclosure. As shown in FIG. 3, the method for obtaining contents of the page according to the embodiment of the disclosure may include steps 101-105.

First, a first website loading module sends a request for obtaining the page to a page server.

The sending of the request is taken place when a system interface intends to load and present the contents of the page. That is to say, when the system interface intends to load and present the contents of the page, the first website loading unit is correspondingly triggered to send the request for obtaining the page to the page server. The first website loading module may be a website loading module NSURLConnection in an existing iOS platform. The request for obtaining the page may include the URL of the requested page.

In the step 101, an intercepting module intercepts the request for obtaining the page.

In the step 102, a second website loading module sends the request for obtaining the page to a proxy module.

In the step 103, the proxy module obtains the contents of the page based on the request for obtaining the page.

For example, corresponding contents of the page may be obtained based on the URL in the request for obtaining the page. The proxy module according to the embodiment may be a proxy server in background.

In the step 104, the proxy module returns the contents of the page to the second website loading module.

In the step 105, the second website loading module returns the contents of the page. According to an embodiment, the second website loading module returns the contents of the page to a system interface, for loading and presenting the contents by the system interface.

The method for obtaining the contents of the page may be implemented with an apparatus for obtaining the contents of the page, including an intercepting module, a second website loading module and a proxy module. The proxy module may be locally arranged. After the intercepting module intercepts the request for obtaining the page, the second website loading module requests for obtaining the contents of the page to the locally arranged proxy module rather than to the page server in an external network. Hence, the loading speed is increased, the loading time is reduced and the loading efficiency is improved.

The method for obtaining the contents of the page has the same mechanism for obtaining the contents of the page as the device embodiments, and reference may be made to the description of the device.

In the method for obtaining the contents of the page according to the embodiment, the first website loading module sends the request for obtaining the page to the page server when the system interface intends to load and present the contents of the page; the intercepting module intercepts the request for obtaining the page; the second website loading module sends the request for obtaining the page to the proxy module; the proxy module obtains the contents of the page based on the request for obtaining the page; the proxy module returns the contents of the page to the second website loading module; and the second website loading module returns the contents of the page to the system interface, for loading and presenting the contents by the system interface. In the technical solution according to the embodiments of the disclosure, the proxy module may obtain the contents of the page based on the request for obtaining the page and the proxy module may be arranged locally. Hence, the problem of slow loading speed, long loading time and low loading efficiency caused by the website loading module requesting the contents of the page from the page server during a heavy load of the page server is avoided. In the technical solution according to the embodiment, since the contents of the page may be obtained from the proxy module, the loading speed may be increased, the loading time may be reduced, the loading efficiency may be improved, and the user experience of a mobile terminal may further be enhanced. In addition, with the technical solution according to the embodiment, the problem that the proxy module in background is not fully used by the system interface is solved. By fully using the proxy module in loading the page, the efficiency of loading the page is improved and the user experience in loading the page is enhanced.

According to another embodiment, the step 103 of obtaining the contents of the page by the proxy module based on the request for obtaining the page may include, obtaining the contents of the page from a local cache by the proxy module based on the request for obtaining the page. That is to say, the contents of the page are already accessed and are stored in the proxy module. The proxy module may locally obtain the contents of the page based on the request for obtaining the page after the second website loading module sends the request for obtaining the page to the proxy module.

Alternatively, in the case the contents of the page are accessed for the first time, i.e., in the case that the contents of the page are not locally stored in the proxy module, the step 103 of obtaining contents of the page by the proxy module based on the request for obtaining the page may include: sending the request for obtaining the page to the page server by the proxy module and receiving the corresponding contents of the page by the proxy module from the page server, where the corresponding contents of the page are sent by the page server based on the request for obtaining the page. Hence, it is ensured that the contents of the page, requested by the request for obtaining the page, may be correctly obtained.

In this embodiment, since the contents of the page are accessed for the first time, the proxy module needs to send a request to the page server for obtaining the contents of the page. Disadvantages of low loading speed and long loading time may be caused. To solve the disadvantages, according to the embodiment of the disclosure, a data transmission protocol between the second website loading module and the proxy module may be different from that between the proxy module and the page server; and/or the data transmission protocol between the second website loading module and the proxy module supports a higher data transmission rate than the data transmission protocol between the proxy module and the page server. That is to say, the data transmission rate between the second website loading module and the proxy module may be increased by applying a data transmission protocol different form that between the proxy module and the page server. Hence, the loading speed is increased, the loading time is reduced and the loading efficiency is ensured.

For example, in the existing iOS platform, a Hypertext transfer protocol (Http) is applied between the website loading module NSURLConnection and the page server. A second website loading module may be added to the existing iOS platform, for example, the second website loading module may be a website loading module Chromium net. To ensure the loading efficiency, an SPDY data transmission protocol supporting a higher data transmission rate may be applied between the second website loading module and the proxy module, while the Http protocol is still applied between the proxy module and the page server. The SPDY data transmission protocol is an enhancement of the Http protocol and the data transmission rate may be significantly improved.

Table 1 shows the time spent for loading the URLs of respective websites illustrated in Table 1 with an existing technical solution and with the technical solution according to the embodiment of the disclosure, and enhancements of speeds. In the existing technical solution, the website loading module NSURLConnection is connected with the page server through the Http protocol, where this connection approach may be called as direct connection. In the technical solution according to the embodiment of the disclosure, the SPDY data transmission protocol is applied between the website loading module Chromium net and the proxy module, where this connection approach may be called as SPDY connection. As shown in Table 1, where five websites illustrated in Table 1 are loaded with both the existing technical solution and the technical solution according to the embodiment of the disclosure, it may be known that with the technical solution according to the embodiment of the disclosure, the loading time is reduced, the loading speed is increased and the loading efficiency is accordingly improved.

TABLE 1

| | Time for direct | Time for SPDY | Enhancements |
|---|---|---|---|
| websites | connection (s) | connection (s) | of speeds |
| 3g.qq.com | 0.8252 | 0.4702 | 43.02% |
| m.taobao.com | 0.6938 | 0.568 | 18.13% |
| 3g.sina.com | 0.619 | 0.4424 | 28.53% |
| m.sohu.com | 1.3078 | 0.529 | 59.55% |
| i.feng.com | 1.7016 | 1.3716 | 19.39% |

According to still another embodiment, after the step 103 of obtaining the contents of the page by the proxy module based on the request for obtaining the page, and before the step 104 of returning the contents of the page to the second website loading module by the proxy module, the method may further include: processing the contents of the page by the proxy module based on a page processing parameter in the request for obtaining the page. The page processing parameter may include at least one of page size, an image compression ratio, a resource compression ratio, and a value reflecting whether to perform advertisement filtering. For example, the value may be set as 1 to reflect that the advertisement filtering is to be performed, while the value may be set as 0 to reflect that the advertisement filtering is not to be performed. Each page processing parameter may be carried by adding fields to the request for obtaining the page.

According to another embodiment, in the step 105 of returning the contents of the page to the system interface by the second website loading, the second website loading module may return the contents of the page through the intercepting module and the first website loading module. For example, firstly, the second website loading module may return the contents of the page to the intercepting module, then the intercepting module returns the contents of the page to the first website loading module, and in the end, the first website loading module returns the contents of the page to the system interface, for loading and presenting the contents by the system interface.

It should be noted that, the technical solutions of the foregoing embodiments may be applied in the iOS platform. The proxy module according to the embodiments may be a proxy server.

It should be noted that, an optional embodiment of the disclosure may be obtained with any combination of optional technical solutions according to the foregoing embodiments, no detail is given here.

In the method for obtaining contents of a page according to the embodiments of the disclosure, by employing the technical solution as disclosed above, the problem of slow loading speed, long loading time and low loading efficiency caused by the website loading module requesting the contents of the page from the page server during a heavy load of the page server is avoided. Hence, the loading speed may be increased, the loading time may be reduced, the loading efficiency may be improved, and the user experience of a mobile terminal may further be enhanced. In addition, with the technical solution according to the embodiment, the problem that the proxy module in background is not fully used by the system interface is solved. By fully using the proxy module in loading the page, the efficiency of loading the page is improved and the user experience in loading the page is enhanced.

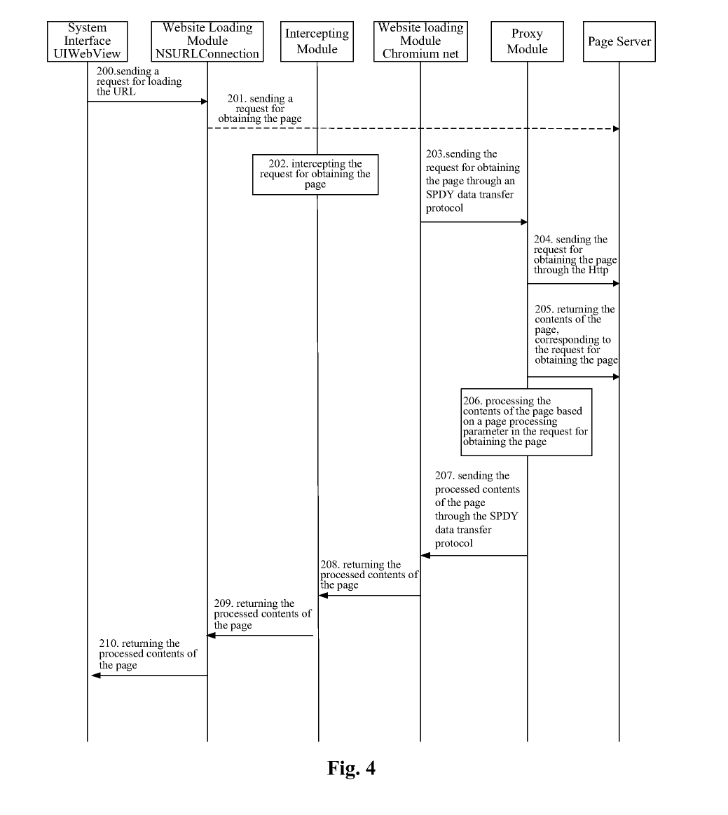

FIG. 4 is a signaling flow chart of a method for obtaining contents of a page according to an embodiment of the disclosure. As an example, the method for obtaining the contents of the page is applied in an iOS platform. Technical solutions of the disclosure are further explained in detail based on FIG. 3 and the optional embodiments. As shown in FIG. 4, the method for obtaining the contents of the page according to the embodiment may include steps 200-210.

In the step 200, when opening a page by using a system interface UIWebView, i.e., when the system interface UIWebView loads the page, the system interface UIWebView loads an URL through a website loading module NSURLConnection, i.e., the system interface UIWebView sends a request for loading the URL to the website loading module NSURLConnection.

According to the embodiment, the website loading module NSURLConnection is taken as a first website loading module.

In the step 201, the website loading module NSURLConnection sends a request for obtaining the page to a page server based on the received request for loading the URL.

Since the request for obtaining the page is to be intercepted in the subsequent step 202, the step 201 is shown in FIG. 4 in a dotted line. According to the embodiment, a Hypertext transfer protocol (Http) is supported between the website loading module NSURLConnection and the page server.

In the step 202, an intercepting module intercepts the request for obtaining the page sent from the website loading module NSURLConnection to the page server.

According to the embodiment, since the Http protocol is applied between the website loading module NSURLConnection and the page server, the request for obtaining the page may be considered as an Http request. The request for obtaining the page may include the URL required to be loaded. The request for obtaining the page may include a page processing parameter, where the page processing parameter may include at least one of page size, a value reflecting whether to perform advertisement filtering and a resource compression ratio. After the intercepting module intercepts the request for obtaining the page, the intercepting module may trigger a website loading module Chromium net to send the request for obtaining the page, which is shown in the step 203.

In the step 203, the website loading module Chromium net sends the request for obtaining the page to a proxy server through an SPDY data transmission protocol.

According to the embodiment, the website loading module Chromium net is taken as a second website loading module. Since the SPDY data transmission protocol is applied between the website loading module Chromium net and the proxy server, the request for obtaining the page is also called as an SPDY frame request. According to the embodiment, a proxy server is taken as the proxy module in the description of the technical solutions of the disclosure.

In the step 204, the proxy server sends the request for obtaining the page to the page server through the Http protocol.

According to the embodiment, in the case that the system interface UIWebView requests for the contents of the page corresponding to the URL, i.e., in the case that the contents of the page corresponding to the URL are not cached in the proxy server, the proxy server is required to request for the contents of the page from the page server.

In the step 205, the page server returns the contents of the page to the proxy server, where the contents of the page correspond to the request for obtaining the page.

In the step 206, the proxy server processes the contents of the page based on a page processing parameter in the request for obtaining the page.

In the step 207, the proxy server sends the processed contents of the page to the website loading module Chromium net through the SPDY data transmission protocol.

In the step 208, the website loading module Chromium net returns the processed contents of the page to the intercepting module.

In the step 209, the intercepting module returns the processed contents of the page to the website loading module NSURLConnection.

In the step 210, the website loading module NSURLConnection returns the processed contents of the page to the system interface UIWebView, so that the system interface UIWebView loads and presents the processed contents of the page.

According to the embodiment, all the processes of returning the contents of the page may be understood as processes in response to the request for obtaining the page. In the end, the mobile terminal may display the processed contents of the page, loaded and presented by the system interface UIWebView, to a user.

In method for obtaining contents of a page according to the present disclosure, by employing the technical solution as described above, the disadvantage that the website loading module requests the contents of the page from the page server and slow loading speed, long loading time and low loading efficiency are caused due to a heavy load of the page server is avoided. Hence, the loading speed may be increased, the loading time may be reduced, the loading efficiency may be improved, and the user experience of a mobile terminal may further be enhanced. In addition, with the technical solution according to the embodiment, the problem that the proxy module in background is not fully used by the system interface is solved. By fully using the proxy module in loading the page, the efficiency of loading the page is improved and the user experience of loading the page is enhanced.

It should be noted that, in the case that the contents of the page, corresponding to the request for obtaining the page, are locally cached in the proxy module, the step 204 and the step 205 may be omitted. Hence, the loading speed is further increased, the loading time is reduced and the loading efficiency is improved.

An application apparatus may further be provided according to an embodiment of the disclosure. The application apparatus includes the described device for obtaining the contents of the page. The detail of the application apparatus is not given here and may be referred to the embodiments illustrating the device for obtaining the contents of the page. In addition, the application apparatus may obtain the contents of the page with the method described above, and the detail is not given here and may be referred to the illustration of the method.

A mobile terminal may further be provided according to an embodiment of the disclosure. The mobile terminal includes at least one application apparatus as described above. The detail of the mobile terminal is not given here and may be referred to the illustration of the corresponding embodiments.

It should be noted that, in the description of the device for obtaining the contents of the page according to the embodiments, the foregoing division of the functional modules is exemplary. In practice, the functions may be implemented by different functional modules as required. That is to say, the inner structure of the device is divided into different functional modules to implement all or part of the described functions. Furthermore, the device for obtaining the contents of the page according to the embodiments is based on the same conception as the embodiments illustrating the method for obtaining the contents of the page, and the implementation of the device may be referred to the description for the method, for which no detail is given here.

Serial numbers of the embodiments are only for illustrative purposes. Merits of the embodiments may not be reflected by the serial numbers.

It should be understood by those skilled in the art that, part of or all of the steps according to the embodiments may be accomplished through hardware or corresponding hardware instructed with a program. The program may be stored in a computer readable storage medium. The computer readable storage medium may include: Read Only Memory (ROM), magnetic disk or Compact Disk. For example, it can be understood by those skilled in the art that the method for obtaining contents of a page according to the disclosure may be achieved by processing units including CPU (central processing unit) or general computing device and storage units including RAM or ROM for storing programs, and accordingly the device for obtaining contents of a page according to the disclosure may be constructed by the processing units and the storage units.

The described embodiments are merely preferred embodiments of the disclosure. The embodiments are not intended to limit the disclosure. Any change, equivalent replacement, modification, etc., without departing from the spirit and principle of the disclosure should fall in the scope of protection of the disclosure.

What is claimed is:

1. A method for obtaining contents of a page, comprising:
intercepting a request for obtaining the page by an intercepting module, wherein the request for obtaining the page is sent from a first website loading module to a page server;
sending the request for obtaining the page to a proxy module by a second website loading module;
obtaining the contents of the page by the proxy module based on the request for obtaining the page;
returning the contents of the page to the second website loading module by the proxy module; and
returning the contents of the page by the second website loading module.

2. The method according to claim 1, wherein obtaining the contents of the page by the proxy module based on the request for obtaining the page comprises:
obtaining the contents of the page from a local cache by the proxy module based on the request for obtaining the page.

3. The method according to claim 1, wherein obtaining contents of the page by the proxy module based on the request for obtaining the page comprises:
sending the request for obtaining the page to the page server by the proxy module; and
receiving the contents of the page from the page server by the proxy module, wherein the contents of the page are sent by the page server based on the request for obtaining the page.

4. The method according to claim 3, wherein a protocol for data transmission between the second website loading module and the proxy module is different from that between the proxy module and the page server; and/or
the protocol for data transmission between the second website loading module and the proxy module supports a higher data transmission rate than the protocol for data transmission between the proxy module and the page server.

5. The method according to claim 1, wherein after obtaining the contents of the page by the proxy module based on the request for obtaining the page, and before returning the contents of the page to the second website loading module by the proxy module, the method further comprises:
processing the contents of the page by the proxy module based on a page processing parameter in the request for obtaining the page.

6. The method according to claim 2, wherein after obtaining the contents of the page by the proxy module based on the request for obtaining the page, and before returning the contents of the page to the second website loading module by the proxy module, the method further comprises:
processing the contents of the page by the proxy module based on a page processing parameter in the request for obtaining the page.

7. The method according to claim 3, wherein after obtaining the contents of the page by the proxy module based on the request for obtaining the page, and before returning the contents of the page to the second website loading module by the proxy module, the method further comprises:
processing the contents of the page by the proxy module based on a page processing parameter in the request for obtaining the page.

8. The method according to claim 4, wherein after obtaining the contents of the page by the proxy module based on the request for obtaining the page, and before returning the contents of the page to the second website loading module by the proxy module, the method further comprises:
processing the contents of the page by the proxy module based on a page processing parameter in the request for obtaining the page.

9. The method according to claim 5, wherein the page processing parameter comprises at least one of resource compression ratio, page size, and a value reflecting whether to perform advertisement filtering.

10. A device for obtaining contents of a page, comprising:
an intercepting module, configured to intercept a request for obtaining the page, wherein the request for obtaining the page is sent from a first website loading module to a page server;
a second website loading module, configured to send the request for obtaining the page to a proxy module, and to return the contents of the page received from the proxy module; and
the proxy module, configured to obtain the contents of the page based on the request for obtaining the page and to return the contents of the page to the second website loading module.

11. The device according to claim 10, wherein the proxy module is configured to obtain the contents of the page from a local cache based on the request for obtaining the page.

12. The device according to claim 10, wherein the proxy module is further configured to send the request for obtaining the page to the page server and to receive the contents of the page from the page server, wherein the contents of the page are sent by the page server based on the request for obtaining the page.

13. The device according to claim 12, wherein a protocol for data transmission between the second website loading module and the proxy module is different from that between the proxy module and the page server; and/or
the protocol for data transmission between the second website loading module and the proxy module supports a higher data transmission rate the protocol for data transmission between the proxy module and the page server.

14. The device according to claims 10, wherein the proxy module is further configured to, after obtaining the contents of the page based on the request for obtaining the page and before returning the contents of the page to the second website loading module, process the contents of the page based on a page processing parameter in the request for obtaining the page.

15. The device according to claims 11, wherein the proxy module is further configured to, after obtaining the contents of the page based on the request for obtaining the page and before returning the contents of the page to the second website loading module, process the contents of the page based on a page processing parameter in the request for obtaining the page.

16. The device according to claims 12, wherein the proxy module is further configured to, after obtaining the contents of the page based on the request for obtaining the page and before returning the contents of the page to the second website loading module, process the contents of the page based on a page processing parameter in the request for obtaining the page.

17. The device according to claims 13, wherein the proxy module is further configured to, after obtaining the contents of the page based on the request for obtaining the page and before returning the contents of the page to the second website loading module, process the contents of the page based on a page processing parameter in the request for obtaining the page.

18. The device according to claim 14, wherein the page processing parameter comprises at least one of resource compression ratio, page size and a value reflecting whether to perform advertisement filtering.

19. A mobile terminal, comprising at least one application apparatus, wherein the application apparatus comprises a device for obtaining contents of a page, and the device comprises:
an intercepting module, configured to intercept a request for obtaining the page, wherein the request for obtaining the page is sent from a first website loading module to a page server;
a second website loading module, configured to send the request for obtaining the page to a proxy module, and to return the contents of the page received from the proxy module; and
the proxy module, configured to obtain the contents of the page based on the request for obtaining the page and to return the contents of the page to the second website loading module.
